(19) United States
(12) Patent Application Publication
(10) Pub. No.: US 2024/0131492 A1
(43) Pub. Date: Apr. 25, 2024

(54) Preparation Method of High-Absorptivity Chitosan/Bamboo Activated Carbon Composite Aerogel

(71) Applicant: SUICHANG WENZHAO BAMBOO CHARCOAL CO., LTD, Lishui (CN)

(72) Inventor: Jirui CHEN, Lishui (CN)

(73) Assignee: SUICHANG WENZHAO BAMBOO CHARCOAL CO., LTD, Lishui, ZJ (CN)

(21) Appl. No.: 18/463,309

(22) Filed: Sep. 7, 2023

Related U.S. Application Data
(63) Continuation of application No. PCT/CN2023/079473, filed on Mar. 3, 2023.

(30) Foreign Application Priority Data
Oct. 23, 2022 (CN) 202211304699.1

(51) Int. Cl. B01J 20/30; B01D 39/18; B01D 39/20; B01J 20/20; B01J 20/24; B01J 20/28; B01J 20/32

(52) U.S. Cl. CPC B01J 20/30; B01D 39/18; B01D 39/2055; B01J 20/20; B01J 20/24; B01J 20/28047; B01J 20/3231; B01D 2253/102; B01D 2253/20; B01D 2253/25

(57) ABSTRACT

A preparation method of a high-absorptivity chitosan/bamboo activated carbon composite aerogel include: evenly mixing a chitosan suspension and bamboo activated carbon; dropwise adding glacial acetic acid and stirring to form a solution; dropwise adding a glutaraldehyde solution, and stirring until cross-linking of chitosan is completed; and freezing the obtained liquid in shape, and then performing freeze-drying by means of a vacuum freeze dryer to obtain a chitosan/bamboo activated carbon composite aerogel. The natural, environmentally friendly and degradable chitosan is used as the raw material, bamboo activated carbon is adhered to the chitosan, and the freeze-drying technique is used to prepare the aerogel, so that the bamboo activated carbon is uniformly dispersed and fixed in the three-dimensional space of the aerogel, and the prepared composite aerogel has a high specific surface area and a high porosity, and a high PM2.5 adsorption capacity.

### FIELD

The invention relates to the field of aerogel, and more particularly relates to a preparation method of a high-absorptivity chitosan/bamboo activated carbon composite aerogel.

### BACKGROUND

Fine particulate matter (PM2.5) is particulate matter with an aerodynamic diameter less than 2.5 μm. It has a small particle diameter and large specific surface area, can easily adsorb toxic and harmful substances in the air, can be inhaled in by humans and even enter the pulmonary alveoli or blood circulation system of humans, directly causing cardiovascular diseases, respiratory diseases or other diseases, which make it one of the most harmful pollutants with the most complex chemical composition in the atmospheric environment. Therefore, it is of great importance to study materials capable of absorbing and filtering PM2.5 efficiently.

Aerogel, as a new three-dimensional porous mesh material, has both microcosmic (nano-scale skeleton) and macroscopic (condensed matter) structural characteristics, and are featured with low density, high porosity and high specific surface area, thus having a broad prospect as a material for adsorbing and filtering harmful gas.

In addition, among substances with a gas-phase adsorption capacity, bamboo activated carbon, as a renewable, environmentally friendly, and low-cost bio-adsorbent, has a great potential. Research finds that the bamboo activated carbon has the features of high porosity and high specific surface area, and the pore structure of the bamboo activated carbon can be further improved after the bamboo activated carbon is activated physically or chemically, so the bamboo activated carbon is an ideal gas-phase adsorption material.

In the prior art, there has not been an aerogel that not only has flame retardance, but also can adsorb PM2.5 produced during combustion, so the application in this aspect lacks scientific and systematic research and needs to be explored.

### SUMMARY

In view of the defects in the prior art, the objective of the invention is to provide a preparation method of a high-absorptivity chitosan/bamboo activated carbon composite aerogel. In this preparation method, an aerogel which can satisfy flame retardance performance and can adsorb PM2.5 produced during combustion is prepared by using chitosan and bamboo activated carbon as main raw materials.

To solve the abovementioned problems in the prior art, the invention provides the following technical solution:

A preparation method of a high-absorptivity chitosan/bamboo activated carbon composite aerogel includes the following steps:
(1) taking chitosan and deionized water to prepare a 0.1-1 wt % chitosan suspension, then adding bamboo activated carbon in an amount which is 0.1-1 wt % of the chitosan suspension by mass, and evenly dispersing the chitosan and the bamboo activated carbon by a magnetic stirrer to form a chitosan/bamboo activated carbon suspension;
(2) dropwise adding glacial acetic acid to the chitosan/bamboo activated carbon suspension obtained in step (1) to maintain the concentration of glacial acetic acid in the suspension at 0.1-0.2 mol/L, and then stirring the chitosan/bamboo activated carbon suspension by the magnetic stirrer until the chitosan is completely dissolved;
(3) taking a solution obtained in step (2), stirring the solution while dropwise adding a glutaraldehyde solution, and keeping stirring the solution by the magnetic stirrer until cross-linking of the chitosan is completed; and
(4) placing the liquid obtained in step (3) in an environment with a temperature lower than 0° C. to freeze the liquid in shape, and then freeze-drying the liquid with a vacuum freeze dryer to obtain the chitosan/bamboo activated carbon composite aerogel.

The invention further includes the following step:
(5) taking the chitosan/bamboo activated carbon composite aerogel obtained in step (4), using methyltrimethoxysilane as a precursor, forming a hydrophobic coating by reaction on a surface of the chitosan/bamboo activated carbon composite aerogel through chemical vapor disposition to obtain a hydrophobic chitosan/bamboo activated carbon composite aerogel with hydrophobic properties.

The invention further provides that, in step (1), the bamboo activated carbon has a particle size of 100-1000 meshes, the rotation speed of the magnetic stirrer is 500-1500 rap/min, and a stirring time is 10-30 min.

The invention further provides that, in step (2), the rotation speed of the magnetic stirrer 500-1500 rap/min, and a stirring time is 10-60 min.

The invention further provides that, in step (3), the glutaraldehyde solution has a concentration of 1-2 wt %, and the amount of the glutaraldehyde solution added dropwise is 0.5-3 wt % of the chitosan suspension by mass.

The invention further provides that, in step (3), the rotation speed of the magnetic stirrer used for completing a cross-linking reaction between the chitosan and glutaraldehyde is 500-1500 rap/min, and the stirring time is 1-5 hrs.

The invention further provides that, in step (4), a free-drying temperature of the vacuum freeze dryer is −196° C. to 20° C., a freeze-drying pressure is 0.5-5 Pa, and a freeze-drying time is 1-5 days.

The invention further provides that, in step (5), a temperature of the chemical vapor deposition is 100-150° C., a holding time is 1-6 hrs, and the chitosan/bamboo activated carbon composite aerogel is taken out and further dried for 0.5-2 hrs after the chemical vapor deposition.

The invention further provides that, an LOI of the prepared chitosan/bamboo activated carbon composite aerogel is 30-40%.

The invention also provides a method for making an adsorbing and filtering system, which uses the chitosan/bamboo activated carbon composite aerogel prepared through a method mentioned in any one of the above as a filter element, further including the following steps:
(a) providing a gas generating bottle, closing a gas outlet of the gas generating bottle, and introducing a harmful gas to be filtered into the gas generating bottle;
(b) arranging a gas pump at a gas inlet of the gas generating bottle, the gas pump being equipped with a flowmeter, introducing a high-pressure gas into the gas generating bottle through the flowmeter to drive the harmful gas to flow forward in a single direction, the gas flow rate being controllable by means of the flowmeter;
(c) sequentially connecting a buffer bottle and an after-filtering bottle to a gas outlet of the gas generating bottle, and arranging a filter element between the buffer bottle and the after-filtering bottle, such that the harmful gas comes into contact with the filter element after passing through the buffer bottle and reaches the after-filtering bottle after being filtered by the filter element; and
(d) connecting a particle counter to a back of the after-filtering bottle, and calculating and evaluating the adsorption efficiency of the filter element.

In addition, the chitosan/bamboo activated carbon composite aerogel prepared by this invention is circular in shape and has a diameter of 5-10 cm and a thickness of 0.1-10 mm.

In the examples of the invention, the harmful gas in step (a) is a simulated PM2.5 gas, which is prepared as follows:

Incense (commercially available) is placed in a sealed glass bottle and is burnt for 5-10 min, preferably 5 min, and 0.1-1 ml, preferably 1 ml, of gas is pumped with a syringe from the glass bottle and then injected into the gas generating bottle. In the invention, connecting ports of the buffer bottle and the after-filtering bottle in step (3) are preferably circular and have a diameter of 5 cm. In addition, in step (d), the particle counter performs the gas capture 1-10 times, preferably 5 times, each for 1-5 min, preferably 1 min, and a formula for calculating the adsorption efficiency is expressed as (1−the number of particles captured in presence of the filter element/the number of particles captured in the absence of the filter element). Specifically, a high-pressure gas may be introduced into the gas generating bottle by means of an air compressor to drive the harmful gas to move.

To sum up, the above technical solutions have the following beneficial effects:
(1) In the invention, the aerogel is prepared through the freeze-drying technique with natural, environmentally friendly and degradable chitosan as the raw material, and bamboo activated carbon is adhered to the chitosan and is uniformly dispersed and fixed in the three-dimensional space of the aerogel, so the prepared bamboo activated carbon/chitosan composite aerogel has a specific surface area of 422.7570 m₂·g⁻¹ and an average pore size of 2.2105 nm. The aerogel has a high specific surface area and a high porosity, and has a high-absorptivity pore structure for PM2.5.
(2) Because chitosan-based aerogels have the defect of poor water resistance, methyltrimethoxysilane is introduced for hydrophobic modification in the invention to prepare a comprehensive multifunctional aerogel with adsorption and hydrophobic properties.
(3) Due to the fact that bamboo activated carbon has a porous microstructure, is typically granular or powdery and loose, is likely to flow with air in use and is inconvenient to process, in this invention bamboo activated carbon is compounded with the chitosan aerogel, such that the bamboo activated carbon is tightly combined with chitosan and is easy to process.
(4) In the invention, chitosan used as the base material of aerogel can be dehydrated into carbon during thermal decomposition to retard combustion, and can also release nontoxic and non-corrosive non-combustible gases such as CO₂, NH₃ and N₂. Bamboo activated carbon itself is a combustible material, but it has the thermal properties of low heat release, small thermal expansion coefficient and high thermal shock resistance, and can assist a carbon coating to expand to resist heat after being compounded with chitosan, such that the LOI of the obtained chitosan/bamboo activated carbon composite aerogel is 30-40%, indicating that the flame retardance is improved instead; and the chitosan/bamboo activated carbon composite aerogel with the LOI greater than 27% is an inflammable substance, proving that the chitosan/bamboo activated carbon composite aerogel prepared in the invention has high flame retardance performance. Particularly, the composite aerogel of this application can absorb PM2.5 produced during combustion while being flame retardant.
(5) An adsorbing and filtering system is made using the chitosan/bamboo activated carbon composite aerogel prepared in the invention as a filter element, a particle counter is provided for testing, and the maximum adsorption efficiency reaches 94.25%, indicating that the filter element made from the chitosan/bamboo activated carbon composite aerogel and the adsorbing and filtering system made using the filter element have a good PM2.5 adsorption capacity.

### BRIEF DESCRIPTION OF THE DRAWINGS

FIG. 1(a) to FIG. 1(d) are analysis charts of the N₂ adsorption-desorption isotherm and pore size distribution of an aerogel obtained in Example 7 and aerogels obtained in Comparative examples 1-3.

FIG. 2 is a chart of the LOT of the aerogel obtained in Example 7 and the aerogels obtained in Comparative examples 1-3.

FIG. 3 is a test chart of the PM2.5 adsorption capacity of the aerogel obtained in Example 7 and an aerogel obtained in Comparative example 4.

FIG. 4 is a test chart of the PM2.5 adsorption capacity of an aerogel obtained in Example 8.

FIG. 5 is a schematic diagram of an adsorbing and filtering system.

Reference Numerals: 1, air compressor; 2, flowmeter; 3, gas generating bottle: 4, buffer bottle; 5, tested sample; 6, after-filtering bottle; 7, particle counter.

### DESCRIPTION OF THE EMBODIMENTS

The invention will be described in further detail below with reference to the accompanying drawings and embodiments. Upon preliminary experiments, the following preferred parameters are obtained:
1. The rotation speed of a magnetic stirrer in step (1), step (2) and step (3) is preferably 800 rap/min.
2. In step (1), the concentration of chitosan used is preferably 1 wt %, the particle size of bamboo activated carbon is preferably 300 meshes, and the stirring time is preferably 15 min.
3. In step (2), the stirring time is preferably 30 min.
4. In step (3), the concertation of a glutaraldehyde solution used is preferably 1 wt %, the proportion of the added glutaraldehyde solution is preferably 1 wt %, and the stirring time is preferably 3 hrs.
5. In step (4), an environment with the temperature lower than 0° C. for freezing in shape is preferably a liquid nitrogen environment; the free-drying temperature of a vacuum freeze drier is preferably from −196° C. to −50° C., the freeze-drying pressure is preferably 0.8-1.2 Pa, and the freeze-drying time is preferably three days.
6. In step (5), the temperature of chemical vapor deposition is preferably 120° C., a holding time is preferably 4 hrs, and a sample is dried preferably for 1 h after being taken out.

In the following description, CS is short for chitosan, GA is short for glutaraldehyde, BAC is short for bamboo activated carbon, MTMS is short for methyltrimethoxysilane, and LOI is short for limiting oxygen index.

### Example 1

Preparation method of a high-absorptivity chitosan/bamboo activated carbon composite aerogel (CS-GA/BAC, 10%)

(1) A 1 wt % chitosan suspension is prepared from a defined quantity of chitosan (300 meshes) and deionized water, then bamboo activated carbon (300 meshes) is added in an amount which is 0.1 wt % of the chitosan suspension by mass and the resulting solution is stirred by a magnetic stirrer at a speed of 800 rap/min for 15 min until the chitosan and the bamboo activated carbon are evenly dispersed in the suspension;

(2) A defined quantity of glacial acetic acid is dropwise added to the chitosan/bamboo activated carbon suspension obtained in step (1) to maintain the concentration of glacial acetic acid in the suspension at 0.2 mol/L, and then the suspension is stirred at a speed of 800 rap/min for 30 min until the chitosan is completely dissolved;

(3) A 1 wt % glutaraldehyde solution is dropwise added to a solution obtained in step (2) in an amount which is 1 wt % of the chitosan suspension by mass while the solution is stirred by the magnetic stirrer at a speed of 800 rap/min for 3 hrs until cross-linking of the chitosan is completed; and

(4) The liquid obtained in step (3) is frozen in shape in the presence of liquid nitrogen, and then is freeze-dried at a temperature of −50° C. and a pressure of 1 Pa by a vacuum freeze dryer for three days to obtain a chitosan/bamboo activated carbon composite aerogel.

### Example 2

This example provides a preparation method of a high-absorptivity chitosan/bamboo activated carbon composite aerogel (CS-GA/BAC, 20%), and differs from Example 1 in that in step (1), the amount of the bamboo activated carbon added to the chitosan suspension is 0.2 wt % of the chitosan suspension by mass.

### Example 3

This example provides a preparation method of a high-absorptivity chitosan/bamboo activated carbon composite aerogel (CS-GA/BAC, 30%), and differs from Example 1 in that in step (1), the amount of the bamboo activated carbon added to the chitosan suspension is 0.3 wt % of the chitosan suspension by mass.

### Example 4

This example provides a preparation method of a high-absorptivity chitosan/bamboo activated carbon composite aerogel (CS-GA/BAC, 40%), and differs from Example 1 in that in step (1), the amount of the bamboo activated carbon added to the chitosan suspension is 0.4 wt % of the chitosan suspension by mass.

### Example 5

This example provides a preparation method of a high-absorptivity chitosan/bamboo activated carbon composite aerogel (CS-GA/BAC, 50%), and differs from Example 1 in that in step (1), the amount of the bamboo activated carbon added to the chitosan suspension is 0.5 wt % of the chitosan suspension by mass.

### Example 6

This example provides a preparation method of a high-absorptivity chitosan/bamboo activated carbon composite aerogel (CS-GA/BAC, 60%), and differs from Example 1 in that in step (1), the amount of the bamboo activated carbon added to the chitosan suspension is 0.6 wt % of the chitosan suspension by mass.

### Example 7

This example provides a preparation method of a high-absorptivity chitosan/bamboo activated carbon composite aerogel (CS-GA/BAC/MTMS), which comprises the following steps:
(1) A 1 wt % chitosan suspension is prepared from a defined quantity of chitosan (300 meshes) and deionized water, and then bamboo activated carbon (300 meshes) is added in an amount which is 0.3 wt % of the chitosan suspension by mass, and the resulting solution is stirred by a magnetic stirrer at a speed of 800 rap/min for 15 min until the chitosan and the bamboo activated carbon are evenly dispersed in the suspension;
(2) A defined quantity of glacial acetic acid is dropwise added to a chitosan/bamboo activated carbon suspension obtained in step (1) to maintain the concentration of glacial acetic acid in the suspension at 0.2 mol/L, and then the suspension is stirred at a speed of 800 rap/min for 30 min until the chitosan is completely dissolved;
(3) A 1 wt % glutaraldehyde solution is dropwise added to the solution obtained in step (2) in an amount which is 1 wt % of the chitosan suspension by mass while the solution is stirred by the magnetic stirrer for 3 hrs until cross-linking of the chitosan is completed;
(4) The liquid obtained in step (3) is frozen in shape in the presence of liquid nitrogen, and then is freeze-dried at a temperature of −50° C. and a pressure of 1 Pa by a vacuum freeze dryer for three days to obtain a chitosan/bamboo activated carbon composite aerogel; and
(5) A chitosan/bamboo activated carbon composite aerogel obtained in step (4) is placed in a 100 ml glass bottle, 0.5 ml of methyltrimethoxysilane is dropwise added to the chitosan/bamboo activated carbon composite aerogel in the glass bottle, the chitosan/bamboo activated carbon composite aerogel is held at a temperature of 120° C. for 4 hrs for chemical vapor deposition, and then is taken out and further dried for 1 h to have reaction on a substrate surface to form a hydrophobic coating, such that a hydrophobic chitosan/bamboo activated carbon composite aerogel is obtained.

### Example 8

This example provides a method for making a harmful gas adsorbing and filtering system using the chitosan/bamboo activated carbon composite aerogel prepared in Examples 1-7.

(1) Incense (commercially available) is placed in a 100 ml sealed glass bottle and then burned for 5 min, and 1 ml of gas is pumped with a syringe from the glass bottle and then injected into a gas generating bottle;

(2) A gas pump is arranged at an inlet of the gas generating bottle, and a gas is introduced into the gas generating bottle at a constant rate of 1.5 NL/min by means of a flowmeter, which drives the harmful gas to flow forward in a single direction;

(3) A buffer bottle and an after-filtering bottle are sequentially connected to a gas outlet of the gas generating bottle, a filter element which has a diameter of 6 cm and is made from the chitosan/bamboo activated carbon composite aerogel is placed between the buffer bottle and the after-filtering bottle, such that the harmful gas reaches the after-filtering bottle after being filtered by the filter element; and

(4) A particle counter is connected to a back of the after-filtering bottle, the harmful gas is captured 5 times, each for 1 min, and the adsorption efficiency of the aerogel is calculated and evaluated.

### Comparative Example 1

Preparation Method of a Chitosan (CS) Aerogel

(1) A 1 wt % chitosan suspension is prepared from a defined quantity of chitosan (300 meshes) and deionized water, and then the chitosan suspension is stirred by a magnetic stirrer at a speed of 800 rap/min for 15 min until the chitosan is evenly dispersed in the suspension;

(2) A defined quantity of glacial acetic acid is dropwise added to the chitosan suspension obtained in step (1) to maintain the concentration of glacial acetic acid in the suspension at 0.2 mol/L, and then the suspension is stirred at a speed of 800 rap/min for 30 min until the chitosan was completely dissolved;

(3) Deionized water is dropwise added to a solution obtained in step (2) in an amount which is 1 wt % the chitosan suspension by mass while the solution is stirred by the magnetic stirrer at a speed of 800 rap/min for 3 hrs; and

(4) The liquid obtained in step (3) is frozen in the presence of liquid nitrogen, and then is freeze-dried at a temperature of −50° C. and a pressure of 1 Pa by a vacuum freeze dryer for three days to obtain a chitosan aerogel.

### Comparative Example 2

Preparation Method of Chitosan-Glutaraldehyde Cross-Linked (SC-GA) Aerogel

(1) A 1 wt % chitosan suspension is prepared from a defined quantity of chitosan (300 meshes) and deionized water, and then the chitosan suspension is stirred by a magnetic stirrer at a speed of 800 rap/min for 15 min until the chitosan and bamboo activated carbon are evenly dispersed in the suspension;

(2) A defined quantity of glacial acetic acid is dropwise added to the chitosan suspension obtained in step (1) to maintain the concentration of glacial acetic acid in the suspension at 0.2 mol/L, and then the suspension is stirred at a speed of 800 rap/min for 30 min until the chitosan is completely dissolved;

(3) A 1 wt % glutaraldehyde solution is dropwise added to a solution obtained in step (2) in an amount which is 1 wt % of the chitosan suspension by mass while the solution is stirred by the magnetic stirrer at a speed of 800 rap/min for 3 hrs until cross-linking of the chitosan is completed; and

(4) The liquid obtained in step (3) is frozen in the presence of liquid nitrogen, and then was freeze-dried at a temperature of −50° C. and a pressure of 1 Pa by a vacuum freeze dryer for three days to obtain a chitosan-glutaraldehyde cross-linked (SC-GA) aerogel.

### Comparative Example 3

Preparation Method of Chitosan/Bamboo Activated Carbon Composite (CS-GA/BAC) Aerogel

(1) A 1 wt % chitosan suspension is prepared from a defined quantity of chitosan (300 meshes) and deionized water, and then bamboo activated carbon (300 meshes) is added in an amount which is 0.3 wt % of the chitosan suspension by mass, and the resulting solution is stirred by a magnetic stirrer at a speed of 800 rap/min for 15 min until the chitosan and bamboo activated carbon are evenly dispersed in the suspension;

(2) A defined quantity of glacial acetic acid is dropwise added to the chitosan suspension obtained in step (1) to maintain the concentration of glacial acetic acid in the suspension at 0.2 mol/L, and then the suspension is stirred at a speed of 800 rap/min for 30 min until the chitosan is completely dissolved;

(3) A 1 wt % glutaraldehyde solution is dropwise added to a solution obtained in step (2) in a mount which is 1 wt % of the chitosan suspension by mass while the solution is stirred by the magnetic stirrer at a speed of 800 rap/min for 3 hrs until cross-linking of the chitosan is completed; and

(4) The liquid obtained in step (3) is frozen in the presence of liquid nitrogen, and then is freeze-dried at a temperature of −50° C. and a pressure of 1 Pa by a vacuum freeze dryer for three days to obtain a chitosan/bamboo activated carbon composite (CS-GA/BAC) aerogel.

### Comparative Example 4

Method for Making a Harmful Gas Adsorbing and Filtering System Using the Chitosan Aerogel Prepared in Comparative Examples 1-3

(1) Incense (commercially available) is placed in a 100 ml sealed glass bottle and then burned for 5 min, and 1 ml of gas is pumped with a syringe from the glass bottle and then injected into a gas generating bottle;

(2) A gas pump is arranged in front of the gas generating bottle, and a gas is introduced into the gas generating bottle at a constant rate of 1.5 NL/min by means of a flowmeter, which drives the harmful gas to flow forward in a single direction;

(3) A buffer bottle and an after-filtering bottle are sequentially connected to the back of the gas generating bottle, a filter element which has a diameter of 6 cm and is made from the chitosan aerogel is placed between the buffer bottle and the after-filtering bottle, such that the harmful gas reaches the after-filtering bottle after being filtered by the filter element; and

(4) A particle counter is connected to a back of the after-filtering bottle, the harmful gas is captured 5 times, each for 1 min, and the adsorption efficiency of the aerogel is calculated and evaluated.

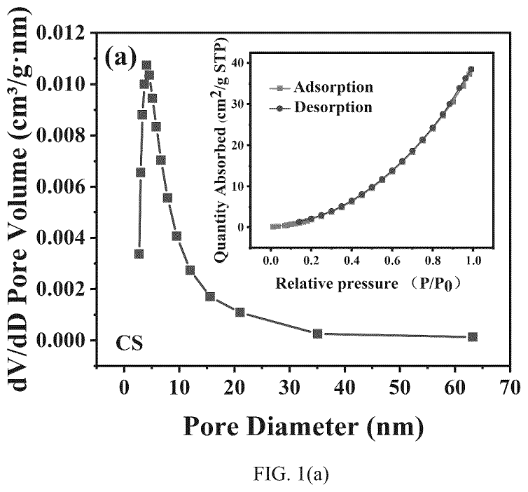

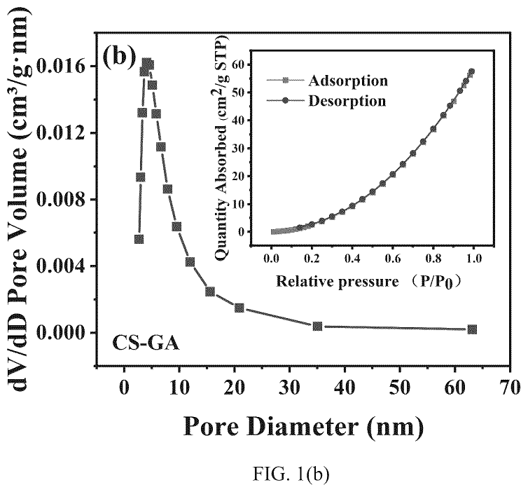

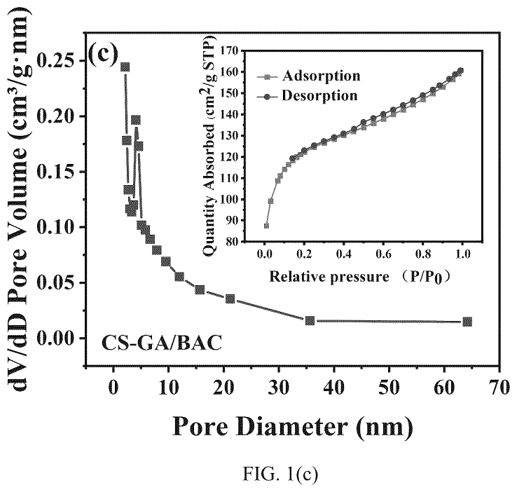

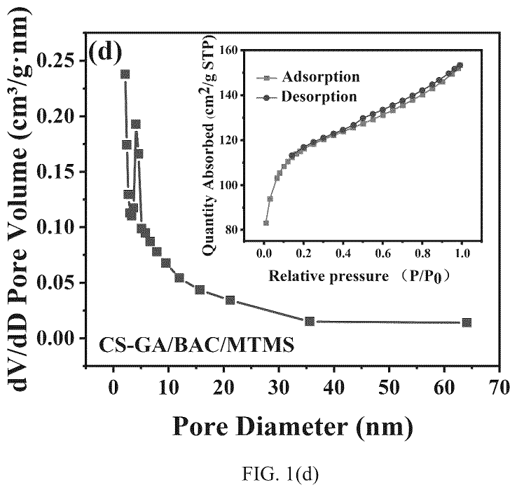

With reference to FIG. 1(a) through FIG. 1(d), the N₂ adsorption-desorption isotherm and pore size distribution analysis of the aerogels in Comparative examples 1-3 and the aerogel in Example 7 are conducted, the surface area and average pore size of the aerogels are calculated, and results are shown in the following table.

| | BET surface | Average |
|---|---|---|
| Sample | area/m₂ · g⁻¹ | pore size/nm |
| CS, Comparative example 1 | 29.2627 | 8.1467 |
| CS-GA, Comparative | 39.1716 | 9.1103 |
| example 1 | | |
| CS-GA/BAC, Comparative | 450.6144 | 2.2105 |
| example 1 | | |
| CS-GA/BAC/MTMS, | 422.7570 | 2.2481 |
| Example 7 | | |

The filtering performance of materials is closely related to the pore structure of the materials. As can be seen, CS and CS-GA have a small specific surface area and a large average pore size, so they supposedly have a limited PM2.5 filtering capacity. By adding BAC, the pore structure of the CS-GA/BAC aerogel is greatly improved, the specific surface area of the CS-GA/BAC aerogel reaches 450.6144m₂·g⁻¹, which is greater than that of a pure bamboo activated carbon, and the pore size of the CS-GA/BAC aerogel is less than that of the pure bamboo activated carbon. In addition, by compositing MTMS through chemical vapor deposition and making it hydrophobic, the CS-GA/BAC/MTMS aerogel obtained still has a good pore structure, with a specific surface area reaching 422.7570 m₂·g⁻¹. In summary, this indicates that the chitosan/bamboo activated carbon composite aerogel has a good pore structure which is beneficial to PM2.5 adsorption.

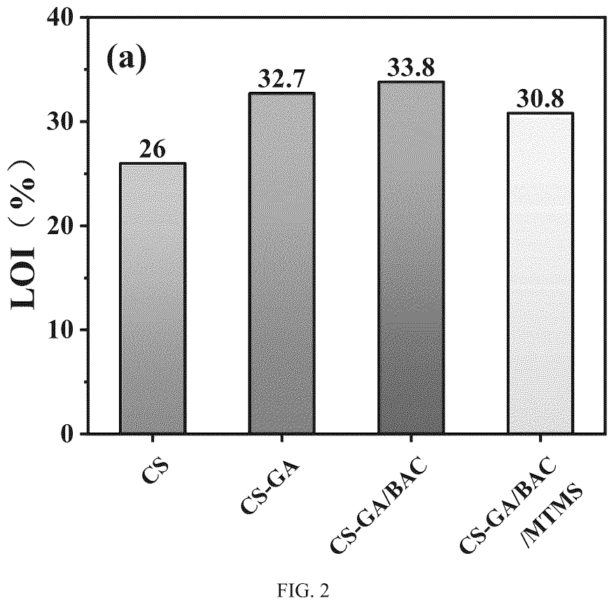

The test results of the LOI of the aerogels obtained in Comparative examples 1-3 and the aerogel obtained in Example 7 are shown in FIG. 2. The LOI of the chitosan aerogel is 26.0%. Generally, substances with the LOI less than 22% are considered as flammable substances, substances with the LOI between 22% and 27% are considered as combustible substances, and substances with the LOI greater than 27% are considered as inflammable substances, so the chitosan aerogel is combustible substance, and the bamboo activated carbon is a combustible material. The LOI of the aerogel modified by cross-linking with glutaraldehyde reaches 32.7% and the LOI of the aerogel added with the bamboo activated carbon reaches 33.8%, indicating that the flame retardance of the composite chitosan aerogel is greatly improved. This is because amino enchained by hydrogen bonds in chitosan are set free after cross-linking and nitrogen can actively participate in reaction during combustion to promote the release of ammonia gas and nitrogen gas to cause a carbon coating to expand to retard flames, and the added bamboo activated carbon can also improve the flame retardance of the aerogel as it can increase of the content of residual carbon in the aerogel and promote the formation of a compact carbon coating to realize solid-phase heat insulation and flame retarding. Compared with the bamboo activated carbon/chitosan aerogel, the bamboo activated carbon/chitosan aerogel modified with MTMS has a relatively low LOI of 30.8% because flammable silane groups grafted on the surface of the aerogel reduce the flame retardance of the aerogel to some extent.

As can be known from above, the chitosan/bamboo activated carbon composite aerogel has good flame retardance, the added bamboo activated carbon can promote the formation of a carbon coating, and nitrogen element in the chitosan can produce ammonia gas and nitrogen gas during combustion and expand the carbon coating, thus realizing solid-phase and gas-phase heat insulation and flame retardance.

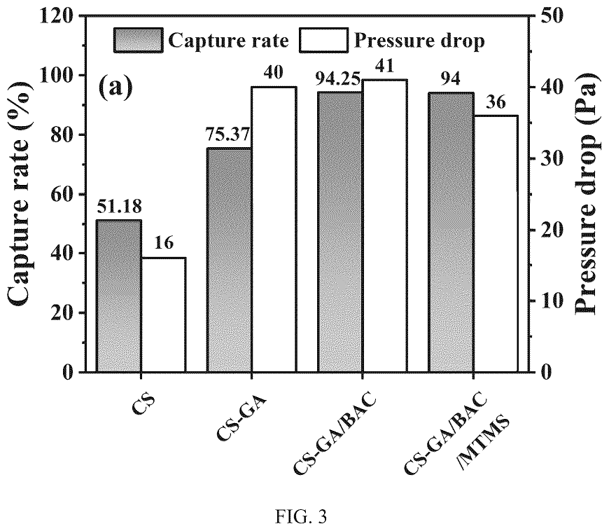

As shown in FIG. 3, the adsorption efficiency of the aerogels in Comparative examples 1-3 and the aerogel in Example 7 is tested, and the chitosan aerogel has a limited PM2.5 adsorption capacity, which is only 51.63%. The adsorption efficiency of the chitosan-glutaraldehyde cross-linked aerogel reaches 75.35%, indicating that cross-linking succeeds. The cross-linked aerogels create intermolecular links to form a parallel laminated structure to improve the PM2.5 adsorption and capture capacity of the aerogel. The PM2.5 adsorption efficiency of the chitosan/bamboo activated carbon aerogel prepared by adding bamboo activated carbon reaches 94.25%, and is remarkably improved compared with the chitosan aerogel and the chitosan-glutaraldehyde cross-linked aerogel, indicating that the bamboo activated carbon dispersed and fixed in the three-dimensional space of the aerogel creates a good adsorption space for the aerogel and forms a composite material with a high PM2.5 adsorption capacity, together with the aerogel.

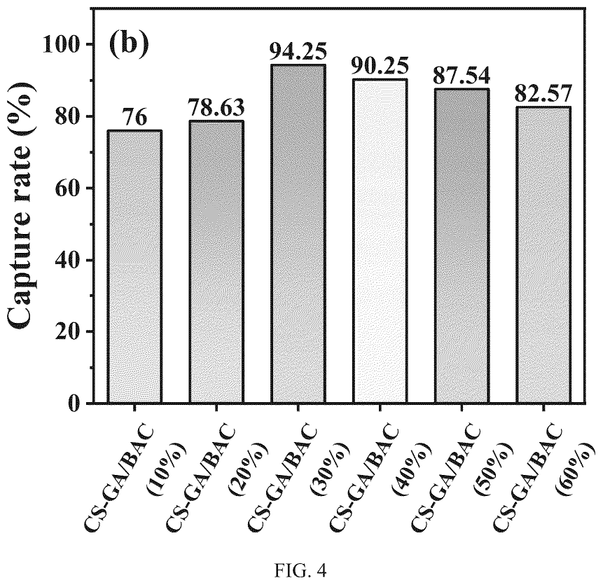

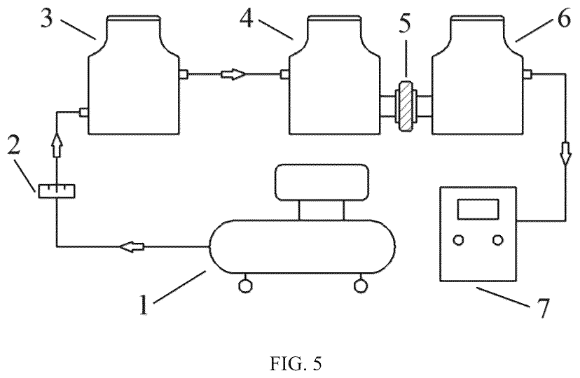

As shown in FIG. 4, the adsorption capacity of the aerogels in Examples 1-6 is tested, the adsorption capacity of the chitosan/bamboo activated carbon composite aerogel increases and then decreases with the content of the bamboo activated carbon, and the aerogel in Example 3 of the invention has the highest PM2.5 adsorption capacity, which reaches 94.25% when the amount of the bamboo activated carbon added is 0.3 wt % of the chitosan suspension by mass.

A water solution containing pigment is dropwise added to the aerogels in Comparative examples 1-3 and Example 7, and it is observed that water drops on the surface of the aerogel modified with MTMS in Example 7 do not permeate into the aerogel and are in a shape of sphere, indicating that the bamboo activated carbon/chitosan aerogel modified with MTMS is hydrophobic to some extent.

The above are merely preferred embodiments of the invention, the protection scope of the invention is not limited to the above embodiments, and all technical solutions based on the concept of the invention should fall within the protection scope of the invention. It should be pointed out that various improvements and modifications obtained by those ordinarily skilled in the art without departing from the principle of the invention should also fall within the protection scope of the invention.

What is claimed is:

1. A preparation method of a high-absorptivity chitosan/bamboo activated carbon composite aerogel, comprising the following steps:
(1) taking chitosan and deionized water to prepare a 0.1-1 wt % chitosan suspension, then adding bamboo activated carbon in an amount which is 0.1-1 wt % of the chitosan suspension by mass, and evenly dispersing the chitosan and the bamboo activated carbon by a magnetic stirrer to form a chitosan/bamboo activated carbon suspension;
(2) dropwise adding glacial acetic acid to the chitosan/bamboo activated carbon suspension obtained in step (1) to maintain the concentration of glacial acetic acid in the suspension at 0.1-0.2 mol/L, and then stirring the chitosan/bamboo activated carbon suspension by the magnetic stirrer until the chitosan is completely dissolved;
(3) taking a solution obtained in step (2), stirring the solution while dropwise adding a glutaraldehyde solution, and keeping stirring the solution by the magnetic stirrer until cross-linking of the chitosan is completed; and
(4) placing the liquid obtained in step (3) in an environment with a temperature lower than 0° C. to freeze the liquid in shape, and then freeze-drying the liquid with a vacuum freeze dryer to obtain the chitosan/bamboo activated carbon composite aerogel.

2. The preparation method of a high-absorptivity chitosan/bamboo activated carbon composite aerogel according to claim 1, further comprising the following step:
(5) taking the chitosan/bamboo activated carbon composite aerogel obtained in step (4), using methyltrimethoxysilane as a precursor, forming a hydrophobic coating by reaction on a surface of the chitosan/bamboo activated carbon composite aerogel through chemical vapor disposition to obtain a hydrophobic chitosan/bamboo activated carbon composite aerogel with hydrophobic properties.

3. The preparation method of a high-absorptivity chitosan/bamboo activated carbon composite aerogel according to claim 1, wherein, in step (1), the bamboo activated carbon has a particle size of 100-1000 meshes, the rotation speed of the magnetic stirrer is 500-1500 rap/min, and a stirring time is 10-30 min.

4. The preparation method of a high-absorptivity chitosan/bamboo activated carbon composite aerogel according to claim 1, wherein, in step (2), the rotation speed of the magnetic stirrer 500-1500 rap/min, and a stirring time is 10-60 min.

5. The preparation method of a high-absorptivity chitosan/bamboo activated carbon composite aerogel according to claim 1, wherein, in step (3), the glutaraldehyde solution has a concentration of 1-2 wt %, and the amount of the glutaraldehyde solution added dropwise is 0.5-3 wt % of the chitosan suspension by mass.

6. The preparation method of a high-absorptivity chitosan/bamboo activated carbon composite aerogel according to claim 1, wherein, in step (3), the rotation speed of the magnetic stirrer used for completing a cross-linking reaction between the chitosan and glutaraldehyde is 500-1500 rap/min, and the stirring time is 1-5 hrs.

7. The preparation method of a high-absorptivity chitosan/bamboo activated carbon composite aerogel according to claim 1, wherein, in step (4), a free-drying temperature of the vacuum freeze dryer is −196° C. to 20° C., a freeze-drying pressure is 0.5-5 Pa, and a freeze-drying time is 1-5 days.

8. The preparation method of a high-absorptivity chitosan/bamboo activated carbon composite aerogel according to claim 1, wherein, in step (5), a temperature of the chemical vapor deposition is 100-150° C., a holding time is 1-6 hrs, and the chitosan/bamboo activated carbon composite aerogel is taken out and further dried for 0.5-2 hrs after the chemical vapor deposition.

9. The preparation method of a high-absorptivity chitosan/bamboo activated carbon composite aerogel according to claim 1, wherein, an LOI of the prepared chitosan/bamboo activated carbon composite aerogel is 30-40%.

10. The preparation method of a high-absorptivity chitosan/bamboo activated carbon composite aerogel according to claim 2, wherein, in step (5), a temperature of the chemical vapor deposition is 100-150° C., a holding time is 1-6 hrs, and the chitosan/bamboo activated carbon composite aerogel is taken out and further dried for 0.5-2 hrs after the chemical vapor deposition.

11. A method for making an adsorbing and filtering system, which uses the chitosan/bamboo activated carbon composite aerogel prepared through a method according to claim 1 as a filter element, comprising:
(a) providing a gas generating bottle, closing a gas outlet of the gas generating bottle, and introducing a harmful gas to be filtered into the gas generating bottle;
(b) arranging a gas pump at a gas inlet of the gas generating bottle, the gas pump being equipped with a flowmeter, introducing a high-pressure gas into the gas generating bottle through the flowmeter to drive the harmful gas to flow forward in a single direction, the gas flow rate being controllable by means of the flowmeter;
(c) sequentially connecting a buffer bottle and an after-filtering bottle to a gas outlet of the gas generating bottle, and arranging the filter element between the buffer bottle and the after-filtering bottle, such that the harmful gas comes into contact with the filter element after passing through the buffer bottle and reaches the after-filtering bottle after being filtered by the filter element; and
(d) connecting a particle counter to a back of the after-filtering bottle, and calculating and evaluating the adsorption efficiency of the filter element.
